(19) United States
(12) Patent Application Publication
(10) Pub. No.: US 2004/0169339 A1
(43) Pub. Date: Sep. 2, 2004

(54) Sealing ring and sealing arrangement, including two such sealing rings

(75) Inventors: Eberhard Bock, Moerlenbach (DE); Peter Schreiner, Limburgerhof (DE); Armin Barth, Gorxheimertal (DE); Rolf Vogt, Oftersheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/770,750

(22) Filed: Feb. 3, 2004

(30) Foreign Application Priority Data
Feb. 8, 2003 (DE) DE103 05 173.2-12

(51) Int. Cl. F16J 15/32

(52) U.S. Cl. 277/549

(57) ABSTRACT

A sealing ring for sealing a machine element includes a stiffening ring of a hard material, a supporting ring having a radial flange positioned adjacent a radial surface of the machine element and a sealing sleeve of an elastomer material connected to the stiffening ring. The sealing sleeve includes a sealing lip for sealing against the radial surface of the machine element so as to create a sealed-off space. The sealing sleeve also incldes an outer axial leg and a radial leg connecting the sealing lip to the outer axial leg. The outer axial leg includes a first end proximate to the sealed-off space and the sealing sleeve is connected to the stiffening ring at the first end. In addition, a sealing arrangement including two such sealing rings.

Priority is claimed to German Patent Application No. DE 103 05 173.2, filed on Feb. 8, 2003, the entire disclosure of which is incorporated by reference herein.

### BACKGROUND

The present invention is directed to a sealing ring, including a sealing sleeve of elastomer material having at least one sealing lip for sealing a space to be sealed off, the sealing sleeve being joined to a stiffening ring of tough, hard material.

Sealing rings of this kind are generally known and are used, for example, as radial shaft seals. In this context, the sealing sleeve and the stiffening ring are vulcanized to one another, the sealing sleeve being flexible in the radial direction, in the area of the sealing lip. In many applications, particularly in those which employ radial shaft seals having an axially short sealing sleeve for sealing off pressurized media, the comparatively low flexibility, i.e., high degree of stiffness is not very satisfactory, since, for example, unbalanced states of the machine element to be sealed and/or operationally induced wear on the sealing lip are not able to be adequately compensated by the sealing ring. To partially compensate for such a design flaw, the previously known sealing rings are installed with a comparatively large radial overlap, i.e., it is inherent in the manufacturing process that the sealing lip have a distinctly smaller diameter than the surface of the machine element to be sealed. However, such a large radial overlap produces a substantial friction moment during operation and results in an undesired, premature manifestation of wear on the sealing lip.

### SUMMARY OF THE INVENTION

An object of the present invention to provide a sealing ring of the type mentioned at the outset having improved working properties over a prolonged service life and having a low friction moment between the sealing sleeve and the machine element to be sealed. A further or alternate object is to provide a sealing ring capable of compensating for eccentric and/or unbalanced states of the machine element to be sealed by providing a sealing lip having an increased range of motion. A further additional or alternate object is to provide a sealing ring which can be manufactured simply and cost-effectively from a standpoint of production engineering and economics. A yet further or alternate object of the present invention is to provide a sealing ring that can be used for sealing off high pressures, for example in the range of up to 200 bar. A still further or alternate object is to provide a sealing ring having a sleeve precisely positioned in relation to the other components of the sealing ring, and to avoid gap extrusion and resulting damage/destruction to the material of the sealing sleeve.

The present invention provides a sealing ring for sealing an axially arranged machine element, that includes a stiffening ring of a hard material; a supporting ring having a radial flange positioned adjacent a radial surface of the machine element so as to form a radial gap between the radial flange and the surface of the machine element; and a sealing sleeve of an elastomer material connected to the stiffening ring, the sealing sleeve including a sealing lip for sealing against the radial surface of the machine element so as to create a sealed-off space, an outer axial leg, and a radial leg connecting the sealing lip to the outer axial leg, wherein the outer axial leg includes an outer circumferential surface and a first end proximate to the sealed-off space, wherein the outer axial leg is connected to the stiffening ring only at the first end, wherein the radial leg has a first surface distal to the sealed-off space, and wherein the first surface and the outer circumferential surface are associated non-adhesively with the supporting ring.

The sealing sleeve, considered in a longitudinal section of the sealing ring, may have a radially outer and a radially inner axial leg, the axial legs being joined on the side facing axially away from the space to be sealed off by a radial leg, for the external axial leg to be joined to the stiffening ring only on the side axially facing the space to be sealed off, and for the outer circumferential surface of the outer axial leg and the end face of the radial leg axially facing away from the space to be sealed off to be associated non-adhesively with a supporting ring, and for the supporting ring to encompass a radial flange, which is positioned adjacently to the surface of the machine element to be sealed, forming a radial gap having only very little radial clearance. An embodiment of this kind provides the sealing lip with a comparatively large range of motion in relation to sealing rings, where the sealing lip is positioned in the immediate vicinity of the stiffening ring and is joined thereto by vulcanization, in particular in the radial direction, in order to be able to compensate for eccentric conditions of the machine element to be sealed. Moreover, due to the non-adhesive association of the outer axial leg and of the radial leg with the supporting ring, and the greater range of motion resulting therefrom, the friction moment between the sealing lip and the machine element to be sealed is reduced, which is particularly advantageous with regard to achieving good working properties over a very long service life; the abrasive wear of the sealing lip in relation to the previously described, related-art sealing ring, is substantially reduced. These advantageous working properties make the sealing ring of the present invention especially well suited for sealing off higher pressures as well. For example, if the sealing ring is used as a pump seal, it is easily possible to seal off pump pressures of up to 200 bar.

One preferred embodiment may provide for the sealing sleeve, considered in a longitudinal section of the sealing ring, to essentially have a C-shaped design and to open axially toward the space to be sealed off.

Because of the very small radial clearance with which the radial flange of the supporting ring surrounds the surface of the machine element to be sealed, the radial width of the radial gap being 0.01 to 0.2 mm, preferably 0.03 to 0.12 mm, it is advantageous that, even when sealing off high pressures, the material of the sealing sleeve is not undesirably extruded to any significant degree into the radial gap. Therefore, the sealing ring exhibits uniformly good working properties over a long service life.

The supporting ring is preferably made of a polymer material, for example of POM (polyoxymethylene) or of a PTFE (polytetrafluoroethylene) compound. A supporting ring made of a self-lubricating material is especially useful when the radial gap has only a very small radial width. Should the mutually facing surfaces of the supporting ring and the machine element to be sealed come in contact with one another during normal operational use of the sealing ring, such contact does not cause damage/destruction to the mutually contacting components; only very little friction is produced when the components touch one another.

In particular, given a very small radial gap between the supporting ring and the shaft, the supporting ring may be designed to extend radially outwardly, approximately as far as the sealing ring itself, and, therefore, be able to center itself within the assembly to be sealed. It is beneficial in this context that the position is precisely defined and is centric. The gap height is constant over the circumference.

The danger of gap extrusion may be further reduced when, on its side facing the surface of the machine element to be sealed, the radial flange has a projecting support extending at least partially underneath the sealing lip and projecting axially in the direction of the space to be sealed off. This projecting support supports the sealing lip even in response to pressurization of approximately 200 bar.

Because of the reduced friction moment, it necessarily follows that that heat generation is comparatively low, as is the transfer of heat to the medium to be sealed off, constituted, for example, of a transmission fluid or hydraulic fluid. The negligible heat transfer to the medium to be sealed off has a positive effect on the ageing of the medium to be sealed off and/or on the decomposition or precipitation of the additives contained in the medium to be sealed off.

One particularly advantageous embodiment provides for the outer circumferential surface and the end face to each be positioned, with clearance, adjacently to the supporting ring and to be able to be placed against the same. Preference is given to such an embodiment within the scope of the present invention, already for the reason that a sealing ring having such a design meets the objective set at the outset particularly well. The outer circumferential surface, in particular, which is positioned, with radial clearance, adjacently to the axial flange of the supporting ring, the radial clearance constituting the radial spring excursion of the sealing lip, effects the advantageous working properties, since the friction moment and the resultant heat generation are substantially reduced due to the exceptional flexibility of the sealing lip in the radial direction, and the sealing lip is able to follow eccentric and/or unbalanced states of the machine element to be sealed, particularly well.

In accordance with another embodiment, the outer circumferential surface is able to touch the supporting ring, resting against the same, and only the front end is positioned, with clearance, adjacently to the supporting ring and is able to be placed against the same. It may be that a sealing ring designed in this manner has more favorable working properties than do conventional sealing rings, due to the non-adhesive association of the outer axial leg with the axial flange of the supporting ring, since the flexibility of the sealing lip is nevertheless greater in the radial direction than when the sealing lip is positioned in the immediate vicinity of the stiffening ring and is vulcanized thereto, however, the flexibility of the sealing lip in the radial direction is limited as compared to the first previously described embodiment.

The outer circumferential surface of the sealing ring may touch the supporting ring, resting against the same.

The stiffening ring and the supporting ring may be separately manufactured and joined to one another nonpositively and/or positively, e.g., by force- and/or form-locking. In this connection, it is advantageous that the material of the stiffening ring and the material of the supporting ring are able to be easily adapted to the circumstances of the particular application. It is possible, for example, for the stiffening ring to be manufactured from metallic material, for example as a deep-drawn angle ring, which is able to be joined simply and cost-effectively, for example by vulcanization, to the elastomer material of the sealing sleeve. The supporting ring may be made of a polymer material, for example of POM or of a PTFE compound, and be pressed by its axial flange into the stiffening ring. The advantage of such a supporting ring is that, even in response to high pressure loading of the sealing ring and/or substantial eccentric and/or unbalanced states of the machine element to be sealed, a satisfactory relative mobility of the sealing sleeve is retained in relation to the supporting ring of friction-reducing material. The stiffening ring may also be coated with elastomer on its axially extending inner surface. This has the advantage that greater radial tolerances of both the stiffening ring, as well as of the supporting ring are acceptable, and, as a result, the rings are able to be manufactured less expensively.

Moreover, in comparison to comparably designed supporting rings of metallic materials, supporting rings of polymer material have a comparatively smaller mass, which is advantageous for many applications.

For example, the two-piece design of the stiffening ring and supporting ring makes it possible, for example, to manufacture more complicated forms of the ring as well, which would not be feasible with a one-piece design.

Another embodiment provides for the stiffening ring and the supporting ring to be formed as one piece, integrally and of the same material. Installation of the sealing ring is advantageously simplified by such an embodiment, as is, equally, recycling following replacement of the sealing ring, for example, as necessitated by operationally induced wear.

The inner axial leg may be surrounded radially on the outside by an annular helical spring to increase the contact pressure of the sealing lip on the surface of the machine element to be sealed. Moreover, the annular helical spring may be used to compensate for the stress relaxation behavior of the elastomer material. In particular, to seal off low pressures in the range of up to three bar, or when high pressures are relieved to nearly ambient pressure, the use of an annular helical spring is advantageous, since the low pressure within the space to be sealed off does not always suffice to effect a sealing-type contact pressure of the sealing lip on the surface of the machine element to be sealed, in cases of high, dynamic shaft eccentricity and high shaft speed, as well, and since the annular helical spring compensates for the sealing lip in the case of manifestation of wear, in response to pressure release, pressing the same against the shaft.

The outer axial leg and/or the radial leg and/or the supporting ring preferably have a friction-reducing surface coating on the mutually facing sides. The surface coating may be constituted, for example, of a PTFE film or of a lacquer. In response to the application of pressures greater than one bar, for example, on the sealing sleeve, on the side facing axially away from the space to be sealed off, the radial leg positions itself against the radial flange of the supporting ring, bracing itself against the same. If the pressure rises further within the space to be sealed off, the outer circumferential surface of the radially outer leg also positions itself against the axial flange, provided that it had previously been positioned, with radial clearance, adjacently to the axial flange of the supporting ring. The friction-reducing surface coating makes the sealing sleeve and the supporting ring movable relatively to one another even when pressure changes occur within the space to be sealed off and/or when it is necessary for the sealing sleeve to compensate for eccentric and/or unbalanced states of the machine element to be sealed. If the supporting ring is not made of a friction-reducing material, such as a PTFE compound or thermoplastic material, but rather of a metallic material, it is simpler from a standpoint of production engineering to apply the friction-reducing surface coating to the supporting ring, than it is to the elastomer material of the sealing sleeve.

By coating the supporting ring, the additional benefit is derived that surface roughness on the supporting ring does not affect the adhesion of the sealing sleeve. An advantageous consideration when developing a surface coating for the sealing sleeve is, for example, that a PTFE film already be able to be placed in the forming tool of the sealing sleeve and be able to be prevulcanized during the forming process.

The sealing lip may be formed by two intersecting conical surfaces, the first cone angle, which is bounded by the first conical surface facing away from the space to be sealed off and by the axis of the machine element to be sealed, being, at most, 10° smaller than the second cone angle formed by the second conical surface axially positioned in the direction of the space to be sealed off, and by the axis. The two cone angles are essentially of approximate equal size. Such an embodiment is advantageous in terms of ensuring a good lubrication of the sealing lip. Operationally induced wear on the sealing lip is thereby reduced to a minimum. As a result, the additional benefit is derived that the length of the inner axial leg may be kept short, so that the contact pressure of the sealing sleeve on the shaft, produced by the pressure to be sealed off, may be kept low.

The supporting ring is preferably designed as an angle ring and has a radial flange and an axial flange, which are used as counter support for the radial leg and for the radially outer axial leg of the sealing sleeve. The first conical surface may have a stiffening bead on the side axially facing the radial flange of the supporting ring, the ratio of the length of the first conical surface to the length of the second conical surface being 0.3 to 0.8. The stiffening bead is especially useful in conjunction with a conical surface which forms a comparatively large first cone angle with the axis of the machine element to be sealed and/or in conjunction with pressures to be sealed off which exceed three bar, for example. In response to pressurization of the sealing sleeve, the stiffening bead positions itself against the side facing the space to be sealed off and, in this way, prevents the sealing lip from folding over and the second conical surface facing the space to be sealed off from positioning itself flat against the surface of the machine element to be sealed, and from thereby seriously degrading the working properties of the sealing ring. The first conical surface, which is shorter than the second conical surface and is provided with the stiffening bead, prevents the sealing lip from folding over.

The stiffening bead may be formed as one piece and integrally with and of the same material as the sealing sleeve. As a result of this simple embodiment, the sealing ring has a simple design entailing few parts and is simple and cost-effective to manufacture.

In accordance with another embodiment, the stiffening bead may be formed by a separately produced back ring which is joined nonpositively and/or positively with the sealing sleeve. The back ring may be made of a PTFE compound, for example. The back ring is preferably snapped into an undercut of the first conical surface non-adhesively, i.e., joined positively. Departing therefrom, it is also possible that the back ring is joined only nonpositively with the sealing sleeve or is associated adhesively therewith. The back ring prevents the elastomer material of the sealing lip from extruding into the space to be sealed off in response to a comparatively higher pressure, and into the ambient environment in response to a comparatively lower pressure. With its radial height, the back ring covers the radial inside end of the radial flange of the supporting ring and, except for a small radial clearance, is positioned adjacently to the surface of the machine element to be sealed during normal operational use of the sealing ring.

In the sealing ring state inherent in the manufacturing process, viewed in a longitudinal half section of the sealing ring, the sealing lip may have an overlap which extends beyond the surface of the machine element to be sealed to a smaller extent than the radial spring excursion of the outer axial leg, corresponding to the radial clearance, between the outer circumferential surface of the outer axial leg and the radially outwardly adjoining axial flange of the supporting ring. It is advantageous that such parameters always ensure a spring excursion of the sealing lip in the radial direction, even the installed state of the sealing ring.

The supporting ring may constitute part of a housing cover. Such a design further simplifies the sealing ring; on the other hand, from a standpoint of production engineering, the manufacturing of the housing cover becomes more complex and, thus, more expensive.

The supporting ring may be joined to a protective lip, which is positioned on the side of the radial flange facing axially away from the sealing lip and which sealingly encloses the surface of the machine element to be sealed. From such a design, one derives the benefit that the protective lip prevents an ingress of impurities from the ambient environment through the radial gap in the direction of the sealing lip. For that reason, the sealing ring may also be easily used in situations where the ambient environment is heavily polluted.

The present invention is also directed to a sealing arrangement including two of the previously described sealing rings.

Sealing arrangements are generally known. They include a sealing ring having a sealing sleeve of elastomer material having at least one sealing lip for sealing a space to be sealed off, the sealing sleeve being joined to a supporting ring of tough, hard material. The sealing arrangements are used, for example, as radial shaft seals. In this context, the sealing sleeve and the stiffening ring are vulcanized to one another, the sealing sleeve being flexible in the radial direction, in the area of the sealing lip. In many applications, particularly in those which employ radial shaft seals having an axially short sealing sleeve for sealing off pressurized media, the comparatively low flexibility, i.e., high degree of stiffness is not very satisfactory, since, for example, unbalanced states of the machine element to be sealed and/or operationally induced wear on the sealing lip are not able to be adequately compensated by the sealing ring. To partially compensate for this design flaw, the previously known sealing rings are installed with a relatively large radial overlap, i.e., the manufacturing process necessitates that the sealing lip have a distinctly smaller diameter than the surface of the machine element to be sealed. However, such a large radial overlap produces a substantial friction moment during operation and results in an undesired, premature manifestation of wear on the sealing lip.

A further object of the present invention is provide a sealing arrangement of the type mentioned at the outset that may be used as a double mechanical shaft sealing ring and to have improved working properties over a prolonged service life. It is intended, in particular, to reduce the friction moment between the sealing sleeve and the machine element to be sealed. It is also intended to better compensate for eccentric and/or unbalanced states of the machine element to be sealed by providing the sealing lip with an increased range of motion. A further or alternate object is to provide a sealing arrangement that can be manufactured simply and cost-effectively from a standpoint of production engineering and economics. A yet further or alternate object is to provide a sealing arrangement that can be used for sealing off high pressures, for example in the range of up to 200 bar.

The present invention provides a sealing arrangement including two sealing rings of the type mentioned in the foregoing.

The present invention provides a sealing arrangement including a first sealing ring having a first sealing sleeve of elastomer material, having at least one sealing lip for sealing a first space to be sealed off, the first sealing sleeve being joined to a first supporting ring of tough, hard material, the first supporting ring having a first radial and a first axial flange, and a second sealing ring having a second sealing sleeve of elastomer material having at least one second sealing lip for sealing a second space to be sealed off, which is positioned axially adjacently to the first space, the second sealing sleeve being joined to a second supporting ring of tough, hard material, the second supporting ring having a second radial and a second axial flange, and the first sealing ring and the second sealing ring being joined to form a preassemblable unit.

Such an embodiment makes it possible for adjacent, pressurized spaces to be reliably sealed off from one another. The double mechanical shaft sealing ring has a simple design and may, therefore, be manufactured simply and cost-effectively. The sealing arrangement may be used, for example, for a bilateral water pump seal, in known methods heretofore for an application of this kind, two separately produced radial shaft seals being installed in opposition to one another.

The first and the second sealing ring may be positioned so as to be laterally inverted with respect to an imaginary radial plane.

The first and the second supporting ring may have a common radial flange and be formed as one piece and of the same material. In this connection, it is advantageous that the number of components which make up the sealing arrangement be reduced to a minimum. For example, it is possible for the two supporting rings to be joined to one another relatively non-rotatably in the area of their two radial flanges, for example in that the radial flanges are welded together.

In accordance with another embodiment, the two supporting rings may be formed by only one single, reshaped sheet-metal part, only one single radial flange constituting the radial flange for both sealing rings.

One advantageous embodiment provides that each of the sealing sleeves, considered in a longitudinal section of the sealing arrangement, essentially has a C-shaped design and opens axially toward the particular space to be sealed off by one radially outer and one radially inner axial leg, respectively, the axial legs on the side facing axially away from the respective space to be sealed off being joined in each instance by one radial leg, that the outer axial leg of each sealing sleeve is joined only on the side axially facing the particular space to be sealed off, to the unattached end of the particular axial flange of the corresponding supporting ring, and that the particular outer circumferential surface of the outer axial leg in question and the end face of the particular radial leg facing axially away from the particular space to be sealed off are associated non-adhesively with the particular radial leg of the supporting ring in question.

In such an embodiment, every sealing lip has a comparatively large range of motion in relation to sealing rings, where the sealing lip is positioned in the immediate vicinity of the stiffening ring and is joined thereto by vulcanization, in particular in the radial direction, in order to be able to compensate for eccentric conditions of the machine element to be sealed and/or for unbalanced states. Moreover, due to the non-adhesive association of the particular outer axial leg and of the particular radial leg with the supporting ring, and the greater range of motion resulting therefrom, the friction moment between the sealing lip and the machine element to be sealed is reduced, which is particularly advantageous with regard to achieving good working properties over a very long service life; the abrasive wear of the sealing lips in relation to the previously described, related-art sealing ring, is substantially reduced. These advantageous working properties make the sealing arrangement of the present invention especially well suited for sealing off higher pressures as well. For example, if the sealing arrangement is used as a pump seal, it is easily possible to seal off pump pressures of up to 200 bar. Because of the very small radial clearance with which the radial flanges of the supporting rings surround the surface of the machine element to be sealed, the radial widths of the radial gaps being 0.01 to 0.2 mm, preferably 0.03 to 0.12 mm, it is advantageous that, even when sealing off high pressures, the material of the sealing sleeves is not undesirably extruded to any significant extent into the radial gap. The sealing arrangement exhibits uniformly good working properties over a long service life.

Because of the reduced friction moment, it necessarily follows that the heat generation is comparatively low, as is the transfer of heat to the medium to be sealed off, constituted, for example, of a transmission fluid or hydraulic fluid. The negligible heat transfer to the medium to be sealed off has a positive effect on the ageing of the medium to be sealed off and/or on the decomposition of the additives contained in the medium to be sealed off.

One particularly advantageous embodiment provides for the outer circumferential surface and the end face in question to be positioned, with clearance, adjacently to the supporting ring in question and to be able to be placed against the same. Preference is given to such an embodiment within the scope of the present invention, for the reason that a sealing arrangement having such a design meets the objective set at the outset particularly well. The outer circumferential surface, in particular, which is positioned, with radial clearance, adjacently to the axial flange of the supporting ring, the radial clearance constituting the radial spring excursion of the sealing lip, effects the advantageous working properties, since the friction moment and the resultant heat generation are substantially reduced due to the exceptional flexibility of the sealing lip in the radial direction, and the sealing lip is able to follow eccentric and/or unbalanced states of the machine element to be sealed, particularly well.

In accordance with another embodiment, the outer circumferential surface in question is able to touch the supporting ring, resting against the same, and only the front end in question is positioned, with clearance, adjacently to the supporting ring in question and is able to be placed against the same. It may be that a sealing ring designed in this manner has more favorable working properties than do conventional sealing rings, due to the non-adhesive association of the outer axial leg with the axial flange of the supporting ring, since the flexibility of the sealing lip is nevertheless greater in the radial direction than when the sealing lip is positioned in the immediate vicinity of the stiffening ring and is vulcanized thereto, however, the flexibility of the sealing lip in the radial direction is limited as compared to the first previously described embodiment.

The particular outer circumferential surface is able to touch the corresponding supporting rings, resting against the same.

The supporting rings may be made of a polymer material, for example of a PTFE compound. The advantage of such supporting rings is that, even in response to high pressure loading of the sealing rings and/or substantial eccentric and/or unbalanced states of the machine element to be sealed, a satisfactory relative mobility of the sealing sleeves is retained in relation to the particular supporting rings made of friction-reducing material.

Moreover, in comparison to comparably designed supporting rings of metallic materials, supporting rings of polymer material have a comparatively smaller mass, which is advantageous for many applications.

The inner axial leg in question may be surrounded radially on the outside by an annular helical spring, to increase the contact pressure of the sealing lip in question on the surface of the machine element to be sealed. Moreover, the annular helical spring may be used to compensate for the stress relaxation behavior of the elastomer material. In particular, to seal off low pressures in the range of up to three bar, the use of an annular helical spring is advantageous, since the low pressure within the space to be sealed off does not always suffice to effect a sealing-type contact pressure of the sealing lip on the surface of the machine element to be sealed, also in cases of high, dynamic shaft eccentricity and high shaft speed.

The outer axial legs and/or the radial legs and/or the supporting rings may have a friction-reducing surface coating on the mutually facing sides. The surface coating may be constituted, for example, of a PTFE film or of a lacquer. In response to the application of pressures greater than one bar, for example, on the sealing sleeve, on the side facing axially away from the space to be sealed, the radial leg positions itself against the radial flange of the supporting ring, bracing itself against the same. If the pressure rises further within the space to be sealed off, the outer circumferential surface of the radially outer leg also positions itself against the axial flange, provided that it had previously been positioned, with radial clearance, adjacently to the axial flange of the supporting ring. Because of the friction-reducing surface coating, the sealing sleeve and the supporting ring are movable relatively to one another even when pressure changes occur within the space to be sealed off and/or when the sealing sleeve must compensate for eccentric and/or unbalanced states of the machine element to be sealed. If the supporting ring is not made of a friction-reducing material, such as a PTFE compound or a thermoplastic material, but rather of a metallic material, it is simpler from a standpoint of production engineering to apply the friction-reducing surface coating to the supporting ring, than it is to the elastomer material of the sealing sleeve.

By coating the supporting ring, the additional benefit is derived that surface roughness on the supporting ring does not affect the adhesion of the sealing sleeve. An advantageous consideration when developing a surface coating for the sealing sleeve is, for example, that a PTFE film already be able to be placed in the forming tool of the sealing sleeve and be able to be prevulcanized during the forming process.

Each of the sealing lips may be formed by two intersecting conical surfaces, the first cone angle, which is bounded by the first conical surface facing away from the particular space to be sealed off and by the axis of the machine element to be sealed, being, at most, 10° smaller than the second cone angle formed by the second conical surface axially positioned in the direction of the particular space to be sealed off, and by the axis. The two cone angles are essentially of approximate equal size. Such an embodiment is advantageous in terms of ensuring a good lubrication of the sealing lips. Operationally induced wear on the sealing lips is thereby reduced to a minimum. As a result, the additional benefit is derived that the length of the inner axial leg may be kept short, so that the contact pressure of the sealing sleeves on the shaft, produced by the pressure to be sealed off, may be kept low.

The supporting rings preferably have an angle ring design and each have a radial and an axial leg which are used as counter support for the radial leg and for the radially outer axial leg of the particular sealing sleeve.

In the state of the particular sealing ring that is inherent in the manufacturing process, viewed in a longitudinal half section of the sealing ring, the particular sealing lip may have an overlap which extends beyond the surface of the machine element to be sealed to a smaller extent than the radial spring excursion of the particular outer axial leg, corresponding to the radial clearance, between the outer circumferential surface of the outer axial leg and the radially outwardly adjoining axial flange of the particular supporting ring. It is advantageous that such parameters always ensure a spring excursion of the sealing lips in the radial direction, even in the installed state of the sealing rings.

### DESCRIPTION OF THE DRAWINGS

The present invention is described in detail below with respect to the drawings, in which:

FIG. 1 shows a first embodiment of a sealing ring according to the present invention.

FIG. 2 shows a second embodiment of a sealing ring according to the present invention.

FIG. 3 shows a third embodiment of a sealing ring according to the present invention.

FIG. 4 shows a fourth embodiment of a sealing ring according to the present invention.

FIG. 5 shows a fifth embodiment of a sealing ring according to the present invention.

FIG. 6 shows a sixth embodiment of a sealing ring according to the present invention.

FIG. 7 shows a seventh embodiment of a sealing ring according to the present invention.

FIG. 8 shows a eighth embodiment of a sealing ring according to the present invention.

FIG. 9 shows a ninth embodiment of a sealing ring according to the present invention.

FIG. 10 shows a tenth embodiment of a sealing ring according to the present invention.

FIG. 11 shows a eleventh embodiment of a sealing ring according to the present invention.

FIG. 12 shows a twelfth embodiment of a sealing ring according to the present invention.

FIG. 13 shows a thirteenth embodiment of a sealing ring according to the present invention.

FIG. 14 shows a fourteenth embodiment of a sealing ring according to the present invention.

FIG. 15 shows a first embodiment of a sealing arrangement according to the present invention.

FIG. 16 shows a second embodiment of a sealing arrangement according to the present invention.

### DETAILED DESCRIPTION

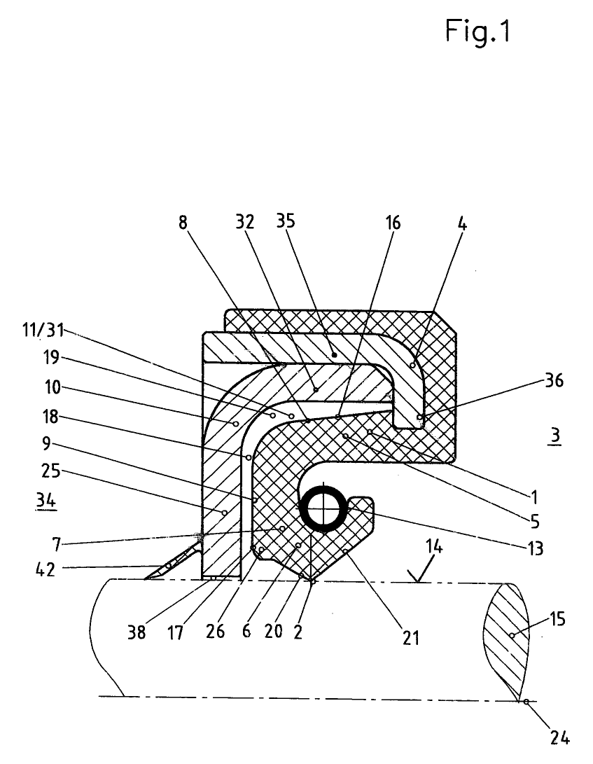

Each of FIGS. 1 through 14 shows an exemplary embodiment of a sealing ring, each of the sealing rings including a sealing sleeve 1 of elastomer material having a sealing lip 2. The sealing rings are depicted in the uninstalled state, as is inherent in the manufacturing process, machine element 15 to be sealed being designed as a shaft and being shown in double dot-dash representation. Space 3 to be sealed is sealed off in that sealing lip 2 sealingly encloses surface 14 of machine element 15 to be sealed under the action of radial prestressing. Within space 3 to be sealed off, the prevailing pressure is comparatively higher than that of ambient environment 34.

Sealing sleeve 1 is joined to stiffening ring 4, which is made of tough, hard material and, in the exemplary embodiments shown here, is designed as a deep-drawn angle ring and is made of metallic material.

In FIGS. 1 through 13, sealing sleeve 1, considered in a longitudinal section of the sealing ring, essentially has a C-shaped design and opens axially toward space 3 to be sealed off.

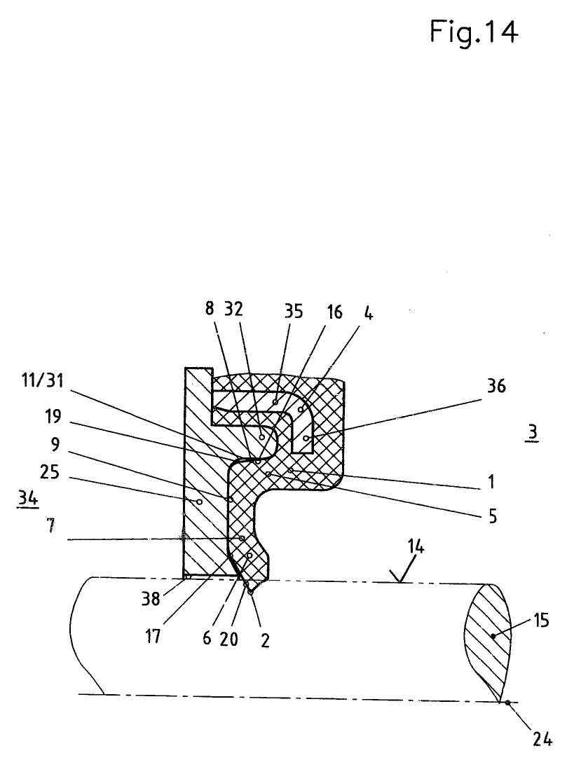

In FIG. 14, the sealing sleeve does not have a C-shaped design.

The sealing sleeve has a radially outer axial leg 5 and a radially inner axial leg 6, the two axial legs 5, 6 being joined on the side facing away from space 3 to be sealed off by radial leg 7. Outer axial leg 5 is joined to stiffening ring 4 only on the side axially facing space 3 to be sealed off, and that outer circumferential surface 8 of outer axial leg 5 and end face 9 of radial leg 7 facing axially away from space 3 to be sealed off are each associated non-adhesively with supporting ring 10. In such an embodiment, sealing lip 2 is especially flexible in the radial direction in order to compensate for eccentric and/or unbalanced states of machine element 15 to be sealed. Nevertheless, an adhesive association of sealing sleeve 1 with stiffening ring 4 is given. Moreover, the friction moment may be reduced by such an embodiment. As a result, the heat generation in the area of sealing lip 2 may be limited to a minimum.

The previously described non-adhesive association between outer circumferential surface 8 of outer axial leg 5 and of end face 9 of radial leg 7 at supporting ring 10 facing axially away from space 3 to be sealed off is the same in all exemplary embodiments shown here, in FIGS. 1 and 3 through 13, sealing rings being shown whose outer circumferential surface 8 and end face 9 are positioned, with clearance 11, 12, respectively, adjacently to supporting ring 10.

The clearances shown in FIGS. 1 through 16 are not shown to scale, but enlarged for the sake of clarity.

In response to relative overpressure within the space to be sealed off and/or eccentric and/or unbalanced states of machine element 15 to be sealed, outer circumferential surface 8 and end face 9 are able to be placed against supporting ring 10. With its radial flange 25, supporting ring 10 very closely approaches surface 14 of machine element 15 to be sealed, so that, in the illustrated examples, radial gap 38 only has a radial width of 0.01 to 0.12 mm. As a result, gap extrusion of the elastomer material of the sealing sleeve into radial gap 36 is substantially avoided, even when sealing off very high pressures in the range of about 200 bar.

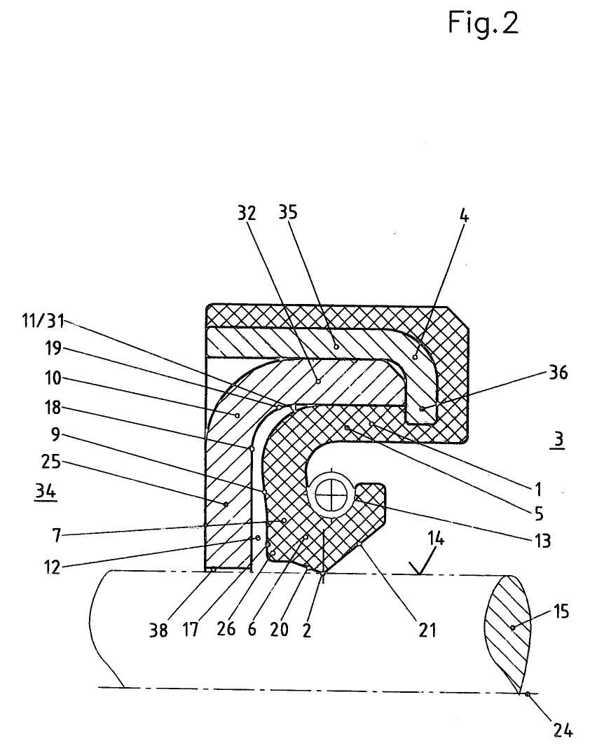

An exemplary embodiment having a deviating design in this regard is illustrated in FIG. 2. Outer circumferential surface 8 touches supporting ring 10, resting against the same, and only end face 9 is positioned, with clearance 12, adjacently to supporting ring 10 and is able to be placed against the same.

In each of the exemplary embodiments shown in FIGS. 1 through 14, the stiffening ring is made of a deep-drawn metallic material, having an axial projection 35 and a radial projection 36, sealing sleeve 1 being configured around radial projection 36 and at least partially covering axial projection 35, radially on the outside. This provides a static sealing action with respect to the installation space of the sealing ring.

Supporting ring 10 is pressed by its axial flange 32 into axial projection 35 of stiffening ring 4 and thereby securely held in position. FIG. 1 shows a first exemplary embodiment. Supporting ring 10 is provided on its side 18 facing axial leg 5 and radial leg 7 of sealing sleeve 1 with a surface coating 19 which is constituted of a PTFE film. Surface coating 19 prevents the elastomer material of sealing sleeve 1 from adhering in response to pressure relief, so that sealing lip 2 is able to spring about its articulation-type connection to radial projection 36.

In FIG. 1, supporting ring 10 is joined to a protective lip 42, which is positioned on the side of radial flange 25 facing axially away from sealing lip 2 and which sealingly encloses surface 14 of machine element 15 to be sealed. A protective lip 42 of this kind which is joined in such a way to supporting ring 10 may also be used in the remaining exemplary embodiments illustrated here. Protective lip 42 prevents the ingress of impurities from ambient environment 34 through radial gap 38 in the direction of sealing lip 2. For that reason, the sealing ring/sealing arrangement of the present invention may also be used when ambient environment 34 is heavily polluted. Even under such operational conditions, the claimed sealing ring/sealing arrangement exhibits uniformly good working properties over a long service life.

FIG. 2 depicts a second exemplary embodiment of the sealing ring which differs from the remaining exemplary embodiments in that outer circumferential surface 8 touches the supporting ring, resting directly against the same. Radial leg 7 is positioned, with axial clearance, adjacently to radial flange 25 on the side facing space 3 to be sealed off. In response to pressurization, radial leg 7 braces itself against radial flange 25.

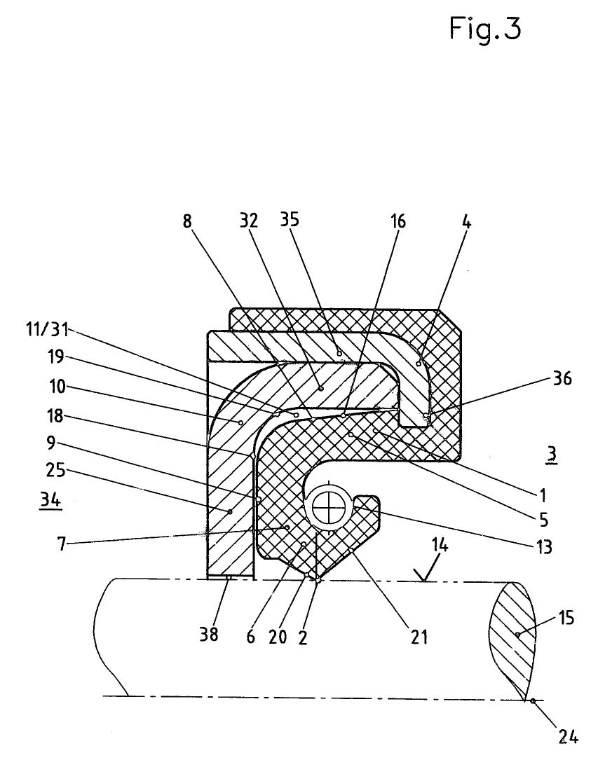

FIG. 3 illustrates a third exemplary embodiment where a supporting ring 10 of polymer material is used. Supporting ring 10 is made of a low-friction polyamide and is able to be manufactured in an injection-molding process. By using the polymer material for supporting ring 10, more complex geometries are able to be implemented, as needed. Because supporting ring 10 is made of a low-friction polyamide, the need is eliminated for applying a separately produced, friction-reducing surface coating.

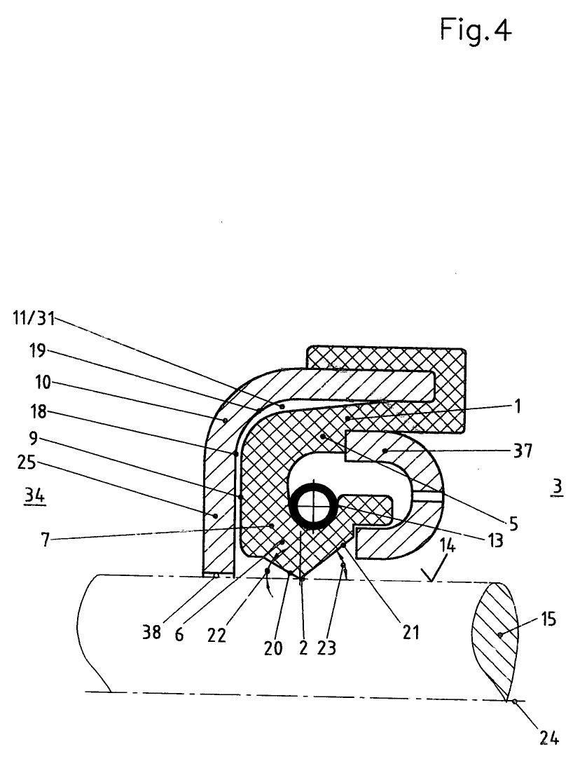

FIG. 4 shows a fourth exemplary embodiment of a sealing ring where stiffening ring 4 and supporting ring 10 are formed as one piece, integrally and of the same material. In addition, on the side facing space 3 to be sealed off, another supporting ring 37 is provided which has the task of preventing sealing lip 2 from tipping in response to too high pressure and in the case of improper assembly. Improper assembly is understood in this connection to be when machine element 15 to be sealed is introduced in this exemplary embodiment from the left into the sealing ring; correct assembly would have to follow from the right, as in the remaining examplary embodiments as well.

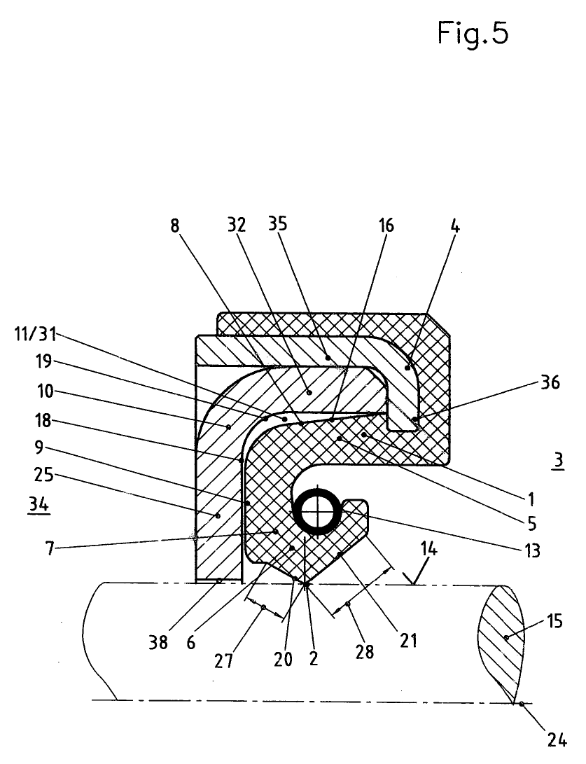

FIG. 5 shows an exemplary embodiment similar to that of FIG. 3, supporting ring 10 being made of a metallic material.

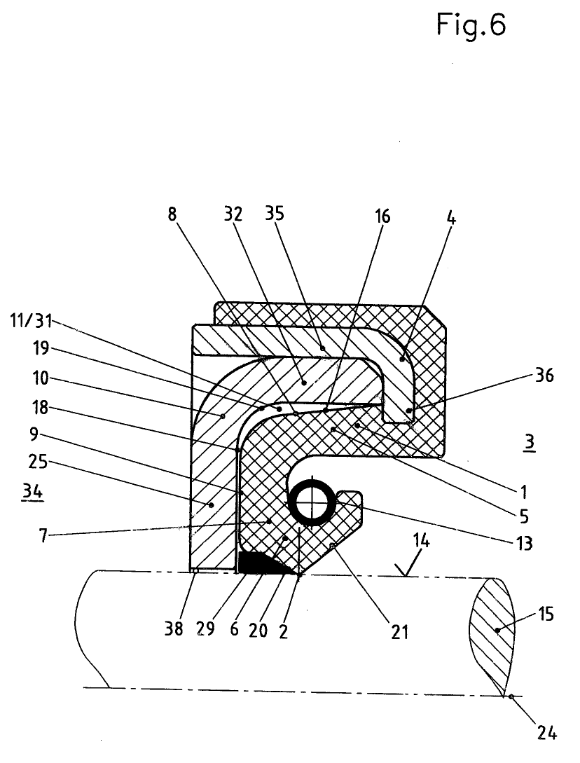

FIG. 6 illustrates a sixth exemplary embodiment. On the side of sealing lip 2 facing away from space 3 to be sealed off, a stiffening bead 26 is provided in the form of a back ring 29. It prevents the elastomer material, which makes up sealing lip 2, from extruding into the sealing gap in response to higher pressures within the space to be sealed off. Moreover, the back ring has the additional task of protecting the seal from wear, and of preventing sealing lip 2 from folding over in a way that would cause second conical surface 21 facing space 3 to be sealed off to rest on surface 14 of machine element 15 to be sealed.

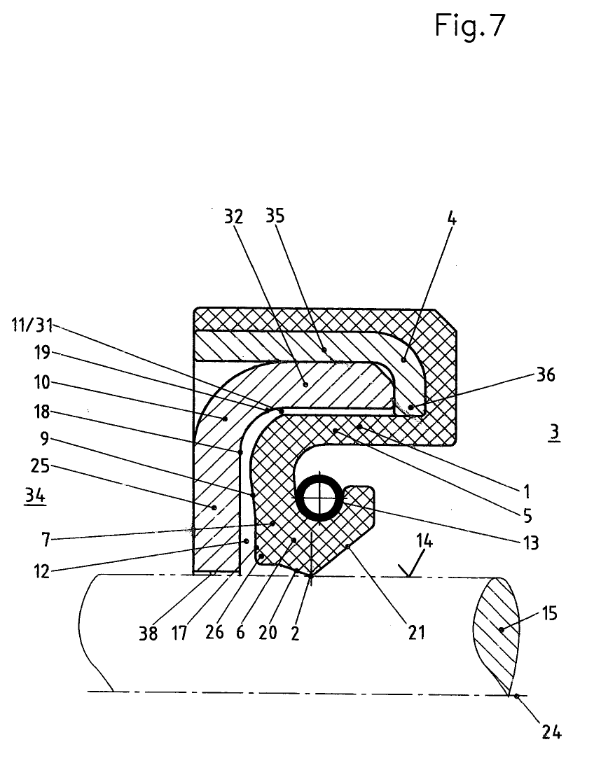

FIG. 7 illustrates a seventh exemplary embodiment of the sealing ring. When considered axially, radial clearance 11 between outer circumferential surface 8 of radially outer axial leg 5 and axial flange 32 of supporting ring 10, is uniform. What is advantageous in an embodiment of this kind is that the tools which are required for manufacturing the sealing ring are simple and, therefore, inexpensive to manufacture.

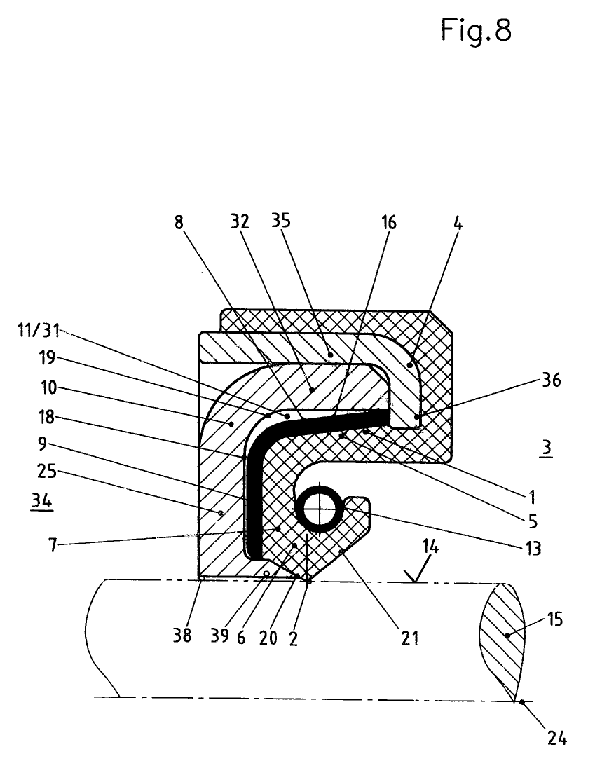

FIG. 8 illustrates an eighth exemplary embodiment of the sealing ring. In contrast to the exemplary embodiment of FIG. 7, radial clearance 11 along the axial extension of the radially outer axial leg is not constant, but rather diminishes continually, axially from radial leg 7, considered in the direction of radial projection 36, as it does in nearly all of the remaining exemplary embodiments. Starting out from radial projection 36, considered in the axial direction, outer circumferential surface 8 gradually positions itself against axial flange 32 of supporting ring 10. Local strain concentrations are thereby avoided.

In this exemplary embodiment, sides 16, 17 of radially outer leg 5 and of radial leg 7 are provided with a friction-reducing surface coating integrally formed as one piece, the surface coating being produced as PTFE film. On its side facing surface 14 of machine element 15 to be sealed, radial flange 25 has a projecting support 39 which protrudes axially in the direction of space 3 to be sealed off and extends underneath sealing lip 2. Deformations of sealing sleeve 1 of undesirable magnitude are avoided during normal operational use in that sealing sleeve 1 braces itself, in the area of its sealing lip 2, against projecting support 39.

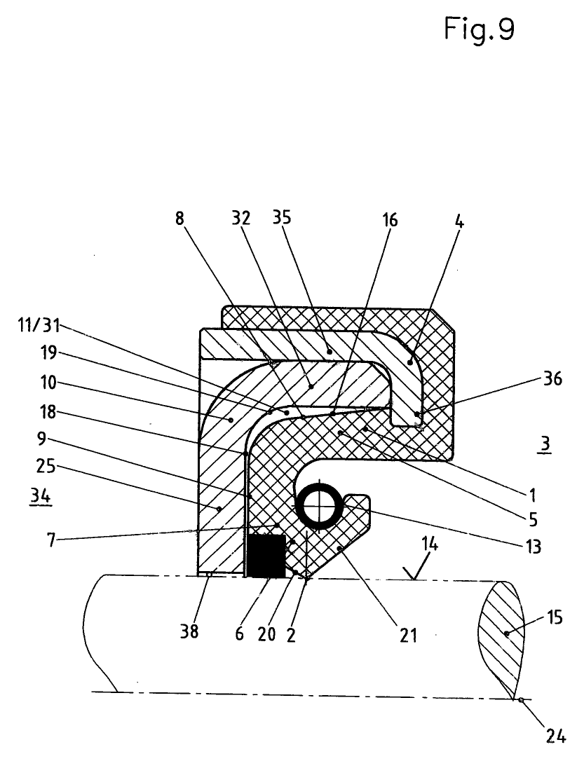

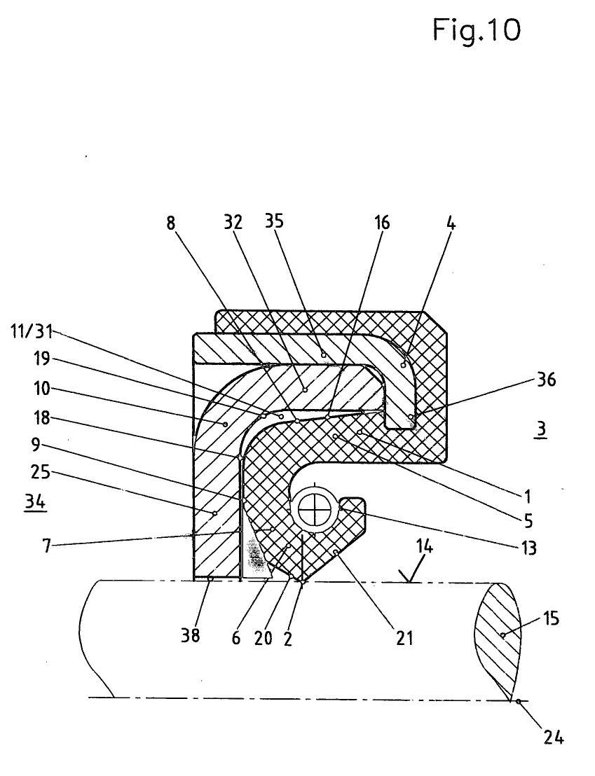

FIGS. 9 and 10 each show an exemplary embodiment that essentially corresponds to that of FIG. 6, the design of back rings 29 used as stiffening bead 26 being variable.

In FIG. 9, back ring 29 has a square shape and prvents sealing lip 2 from extruding into the sealing gap, as well as the sealing lip from tipping toward ambient environment 34. The square geometry of back ring 29 is able to be produced cost-effectively and reliably in terms of process.

In FIG. 10, back ring 29 has a wedge-shaped design and is likewise made of a polymer material having good abrasion resistance and strength properties. Even in response to low operational pressures, back ring 29 encloses surface 14 of machine element 15 to be sealed, with radial clearance, so that, altogether, there is only very little friction moment, and, consequently, very little heat generated by the friction, as well. This back ring 20 also prevents the extrusion of elastomer material of sealing sleeve 1 toward the ambient environment in response to higher system pressures within the space to be sealed off.

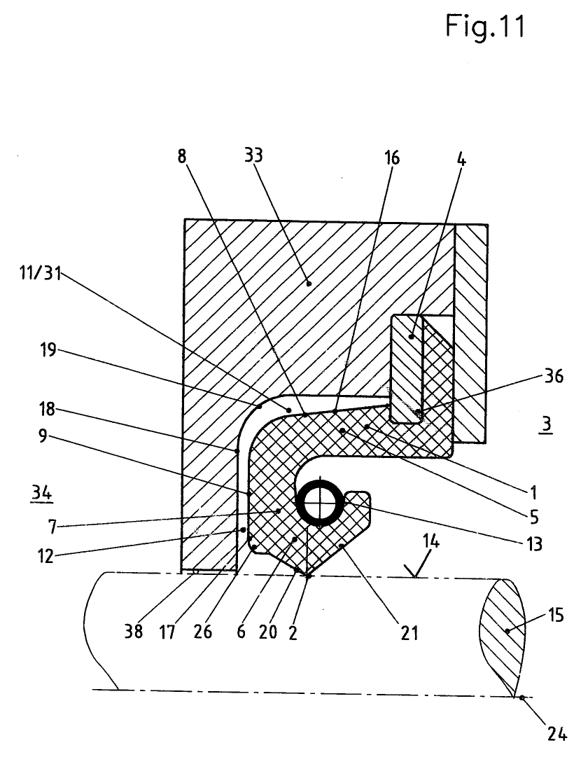

In FIG. 11, an eleventh exemplary embodiment is shown, in which supporting ring 10 constitutes a part of a housing cover 33.

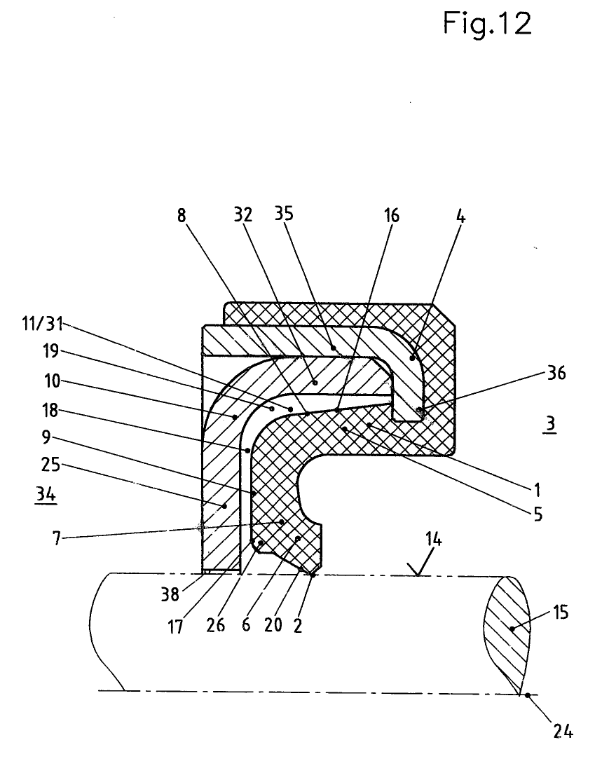

FIG. 12 depicts an exemplary embodiment of a sealing ring similar to the previously described exemplary embodiments, no annular helical spring 13 being used, however. This variant has the advantage that the seal produces smaller radial forces in nonpressurized operation, since the initial pressure force is merely produced by sealing lip 2 overlapping surface 14 of machine element 15 to be sealed. Altogether, therefore, the sealing lip exhibits less wear and an improved efficiency.

In all of the exemplary embodiments shown, first cone angle 22 and second cone angle 23 appear to be essentially equal in size. In each of the exemplary embodiments, sealing lip 2 is formed by two intersecting conical surfaces 20, 21, first cone angle 22, which is bounded by first conical surface 20 facing the space to be sealed off and by axis 24 of machine element 15 to be sealed, being, at most, 10° smaller than second cone angle 23 formed by second conical surface 21 axially positioned in the direction of space 3 to be sealed off, and by axis 24.

As a result of the configuration of stiffening bead 26, which is partially formed as a back ring 29, the ratio of length 27 of first conical surface 20 to length 28 of second conical surface 21 is 0.3 to 0.8 in the exemplary embodiments shown here.

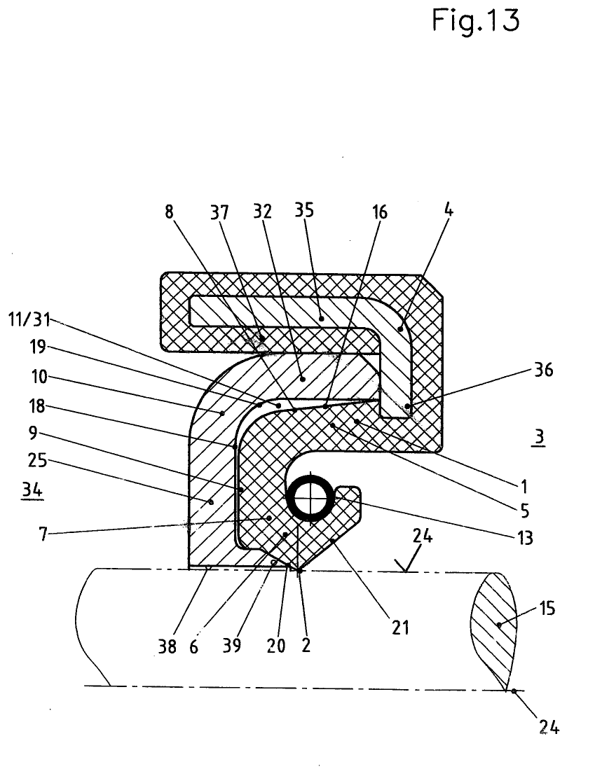

An exemplary embodiment is illustrated in FIG. 13 where axial projection 35 is coated on its inner side with elastomer 37. This has the advantage that greater radial tolerances of both stiffening ring 4, as well as of supporting ring 10 have no disadvantageous effects, so that rings 4, 10 are able to be manufactured less expensively.

As in FIG. 8 as well, radial flange 25 of supporting ring 10 is provided on its side facing surface 14 of machine element 15 to be sealed with a projecting support 39 which protrudes axially in the direction of space 3 to be sealed off and extends underneath sealing lip 2.

FIG. 14 shows another exemplary embodiment which differs from those previously described in that sealing sleeve 1 does not have a C-shaped design. Moreover, supporting ring 10 extends radially outwardly and is able to center itself within the assembly to be sealed.

In the exemplary embodiments shown here, in the sealing ring state inherent in the manufacturing process, viewed in a longitudinal half section of the sealing ring, sealing lip 2 has an overlap 30 which is smaller than radial spring excursion 31 of outer axial leg 5, corresponding to radial clearance 11, between outer circumferential surface 8 of the outer axial leg and radially outwardly adjoining axial flange 32 of supporting ring 10. This holds for all exemplary embodiments, with the exception of that of FIG. 2, where a radial spring excursion is not provided. The described relation between overlap 30 and radial clearance 11/corresponding spring excursion 31 ensures that a radial spring excursion 31 is also retained when the sealing ring and the machine element to be sealed are assembled together.

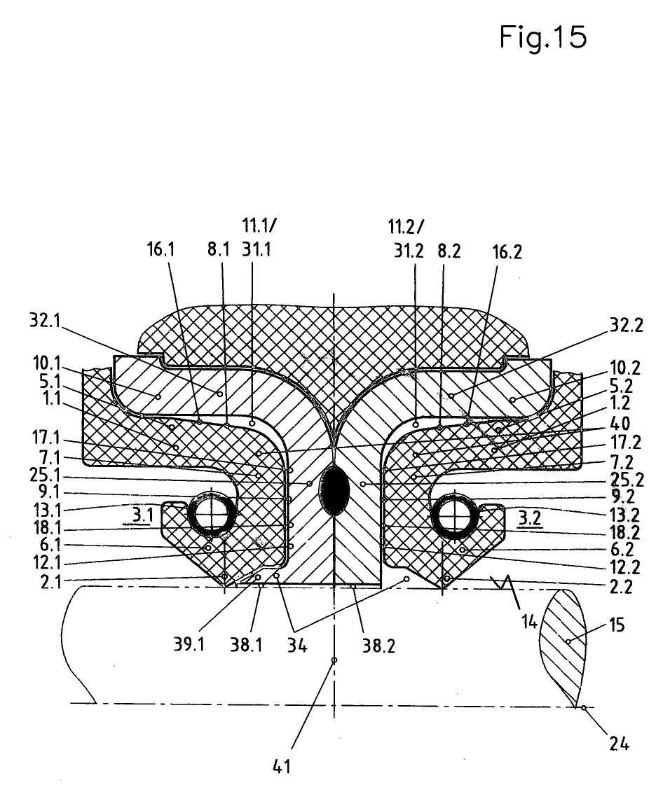

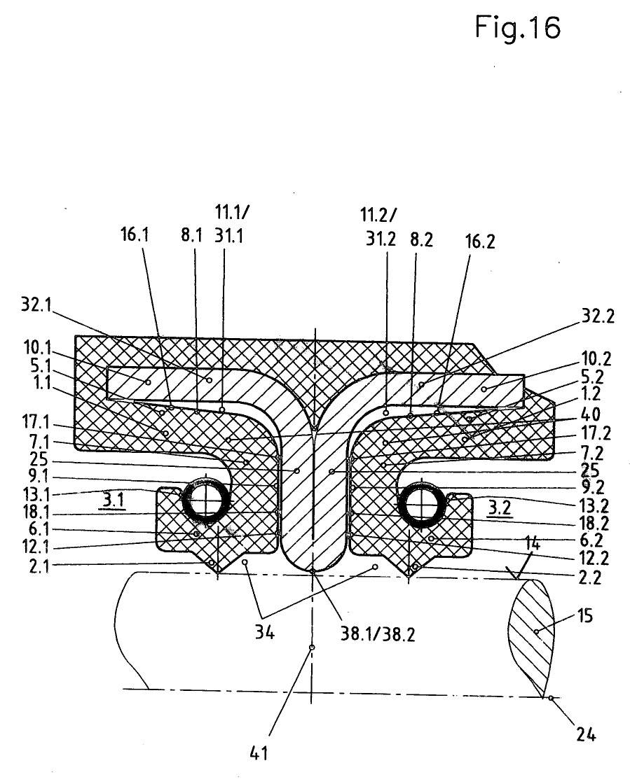

FIGS. 15 and 16 each show an exemplary embodiment of a sealing arrangement, each of the sealing arrangements encompassing two sealing sleeves 1.1, 1.2 of elastomer material and each of sealing sleeves 1.1, 1.2 having a sealing lip 2.1, 2.2. The sealing arrangements are depicted in the uninstalled state, as is inherent in the manufacturing process, machine element 15 to be sealed being designed as a shaft and being shown in double dot-dash representation. Spaces 3.1, 3.2 to be sealed are sealed off in that sealing lips 2.1, 2.2 sealingly enclose surface 14 of machine element 15 to be sealed under the action of radial prestressing. Within spaces 3.1, 3.2 to be sealed off, the prevailing pressure is comparatively higher than that of ambient environment 34.

Each of sealing sleeves 1.1, 1.2 is joined to a supporting ring 10.1, 10.2 which is made of tough, hard material and, in the exemplary embodiments shown here, is designed as a deep-drawn angle ring and is made of metallic material.

Sealing sleeves 1.1, 1.2, considered in a longitudinal section of the sealing arrangement, essentially have a C-shaped design and open axially toward particular space 3.1, 3.2 to be sealed off. First supporting ring 10.1 is provided with a first radial flange 25.1 and a first axial flange 32.1; second supporting ring 10.2 with a second radial flange 25.2 and a second axial flange 32.2. The two sealing rings are joined to form a preassemblable unit 40.

To seal off axially adjacent spaces 3.1, 3.2, the two sealing rings are positioned so as to be laterally inverted with respect to an imaginary radial plane 41. In accordance with the embodiment of FIG. 1, the two radial flanges 25.1, 25.2 are joined to one another relatively non-rotatably, in this exemplary embodiment by spot welding. In contrast, in FIG. 2, first 10.1 and second supporting ring 10.2 are formed in one piece and of the same material and, therefore, share one radial flange 25.

Each of sealing sleeves 1.1, 1.2 has one radially outer 5.1, 5.2 and one radially inner axial leg 6.1, 6.2, respectively, axial legs 6.1, 6.2 on the side facing axially away from the particular space 3.1, 3.2 to be sealed off being joined by a radial leg 7.1, 7.2, respectively. Outer axial leg 5.1, 5.2 of sealing sleeve 1.1, 1.2, respectively, is joined only on the side axially facing space 3.1, 3.2 to be sealed off, respectively, to the unattached end of particular axial flange 32.1, 32.2 of corresponding supporting ring 10.1, 10.2. Outer circumferential surface 8.1, 8.2 of outer axial leg 5.1, 5.2, respectively, and end faces 9.1, 9.2 of radial leg 7.1, 7.2, respectively, facing axially away from space 3.1, 3.2 in question to be sealed off, are thus associated non-adhesively with supporting ring 10.1, 10.2, in question. It is only in such an embodiment that sealing lips 2.1, 2.2 are especially flexible in the radial direction in order to compensate for eccentric and/or unbalanced states of the machine element to be sealed. With their radial flanges 25, 25.1, 25.2, supporting rings 10.1, 10.2 very closely approach surface 14 of machine element 15 to be sealed, so that, in the illustrated examples, radial gap 38, 38.1, 38.2 only has a radial width of 0.03 to 0.08 mm. As a result, gap extrusion of the elastomer material of the sealing sleeve into radial gap 38, 38.1, 38.2 is substantially avoided, even when sealing off very high pressures in the range of about 200 bar.

Moreover, the friction moment is reduced by such an embodiment. As a result, the heat generation in the area of the two sealing lips 2.1, 2.2 is limited to a minimum.

The previously described non-adhesive association between outer circumferential surfaces 8.1, 8.2 of outer axial legs 5.1, 5.2, respectively, and of end faces 9.1, 9.2 in question facing axially away from spaces 3.1, 3.2 to be sealed off, of radial legs 7.1, 7.2 at supporting rings 10.1, 10.2 is the same in the exemplary embodiments shown here. Outer circumferential surfaces 8.1, 8.2 and end faces 9.1, 9.2 are positioned adjacently to supporting rings 10.1, 10.2, respectively, in each instance with clearance 11.1, 11.2, 12.1, 12.2. In response to relative overpressure within spaces 3.1, 3.2 to be sealed off and/or eccentric and/or unbalanced states of machine element 15 to be sealed, outer circumferential surface 8.1, 8.2 and end faces 9.1, 9.2 are able to be placed against supporting rings 10.1, 10.2, respectively.

In the exemplary embodiments illustrated here, first cone angle 22.1, 22.2 and second cone angle 23.1, 23.2 appear to be essentially equal in size. Sealing lips 2.1, 2.2 are formed in each of the exemplary embodiments by two intersecting conical surfaces 20.1, 21.1, 20.2, 21.2, respectively, first cone angle 22.1, 22.2, which is bounded by first conical surface 20.1, 20.2 facing space 3.1, 3.2 to be sealed off and by axis 24 of machine element 15 to be sealed, being, at most, 10° smaller than second cone angle 23.1, 23.2, formed by second conical surface 21.1, 21.2 axially positioned in the direction of space 3.1, 3.2 to be sealed off, and by axis 24.

In the exemplary embodiments shown here, in the state of the particular sealing ring that is inherent in the manufacturing process, viewed in a longitudinal half section of the sealing arrangement, sealing lips 2.1, 2.2 have an overlap 30 which is smaller than radial spring excursion 31.1, 31.2 of outer axial leg 5.1, 5.2, respectively, corresponding to radial clearance 11.1, 11.2, between its outer circumferential surface 8.1, 8.2 and radially outwardly adjoining axial flange 32.1, 32.2 of supporting ring 10.1, 10.2. The relation between overlap 30.1, 30.2 and radial clearance 11.1, 11.2/corresponding spring excursion 31.1, 31.2 ensures that a radial spring excursion 31.1, 31.2 is also retained when the sealing ring and the machine element to be sealed are assembled together.

In FIG. 15, first supporting ring 10.1 is provided with a supporting-ring projection 39, which protects inner axial leg 6.1 from undesirably high mechanical loads, even under very high pressure, for example in the range of 200 bar, which can prevail in first space 3.1 to be sealed off.

FIG. 16 shows the stiffening ring and supporting ring in a one-piece design.

What is claimed is:

1. A sealing ring for sealing an axially arranged machine element, comprising:
a stiffening ring of a hard material;
a supporting ring having a radial flange positioned adjacent a radial surface of the machine element so as to form a radial gap between the radial flange and the radial surface of the machine element; and
a sealing sleeve of an elastomer material connected to the stiffening ring, the sealing sleeve including a sealing lip for sealing against the radial surface so as to create a sealed-off space, an outer axial leg, and a radial leg connecting the sealing lip to the outer axial leg, wherein the outer axial leg includes an outer circumferential surface and a first end proximate to the sealed-off space, the outer axial leg being connected to the stiffening ring only at the first end, wherein the radial leg has a first surface distal to the sealed-off space, and wherein the first surface and the outer circumferential surface are associated non-adhesively with the supporting ring.

2. A sealing ring for sealing an axially arranged machine element, comprising:
a stiffening ring of a hard material;
a supporting ring having a radial flange positioned adjacent a radial surface of the machine element so as to form a radial gap between the radial flange and the radial surface of the machine element; and
a sealing sleeve of an elastomer material connected to the stiffening ring, the sealing sleeve including a sealing lip for sealing against the radial surface so as to create a sealed-off space, an inner axial leg, an outer axial leg, and a radial leg, wherein each of the inner and outer axial legs include a first end proximate to the sealed-off space and a second end distal to the sealed off space, wherein the outer axial leg is connected to the stiffening ring only at the first end, wherein the radial leg connects the second ends of the inner and outer axial legs, and wherein a first surface of the radial leg distal to the sealed-off space and an outer circumferential surface of the outer axial leg are associated non-adhesively with the supporting ring.

3. The sealing ring as recited in claim 2, wherein a longitudinal section of the sealing sleeve forms an essentially C-shape that opens axially toward the sealed-off space.

4. The sealing ring as recited in claim 1, wherein a radial width of the radial gap is 0.01 to 0.2 mm.

5. The sealing ring as recited in claim 4, wherein the radial width of the radial gap is 0.03 to 0.12 mm.

6. The sealing ring as recited in claim 1, wherein the supporting ring is made of a polymer material.

7. The sealing ring as recited in claim 1 wherein, the radial flange includes, at an end of the radial flange proximate to the radial surface, a projecting support protruding axially toward the sealed-off space and extending at least partially underneath the sealing lip.

8. The sealing ring as recited in claim 1, wherein the outer circumferential surface and the first surface are disposed adjacent the supporting ring with a clearance therebetween and are configured to be moveable to a position against the supporting ring.

9. The sealing ring as recited in claim 1, wherein the outer circumferential surface rests against the supporting ring, and the first surface is disposed adjacent the supporting ring with a clearance therebetween, the first surface configured to be moveable to a position against the supporting ring.

10. The sealing ring as recited in claim 1, wherein the stiffening ring and the supporting ring are distinct parts and joined to one another.

11. The sealing ring as recited in claim 1, wherein the stiffening ring and the supporting ring are integrally formed as a single part.

12. The sealing ring as recited in claim 1, wherein at least one of the stiffening ring and the supporting ring include a metallic material.

13. The sealing ring as recited in claim 1, wherein at least one of the the stiffening ring and the supporting ring include a polymer material.

14. The sealing ring as recited in claim 2, further comprising an annular helical spring disposed around an outside of the inner axial leg so as to increase a contact pressure of the sealing lip on the radial surface of the machine element.

15. The sealing ring as recited in claim 1, wherein at least one of the outer circumferenital surface, the first surface, and the supporting ring have a friction-reducing surface coating.

16. The sealing ring as recited in claim 15, wherein the surface coating includes a PTFE film.

17. The sealing ring as recited in claim 15, wherein the surface coating includes a lacquer.

18. The sealing ring as recited in claim 1, wherein the sealing sleeve includes a first conical surface distal to the sealed-off space and a second conical surface proximate to the sealed-off space, the first conical surface intersecting the second conical surface so as to form the sealing lip, a first cone angle formed by the first conical surface and an axis of the machine element being not more than 10° smaller than a second cone angle formed by the second conical surface and the axis.

19. The sealing ring as recited in claim 1, wherein the supporting ring includes an axial flange extending at an angle from the radial flange.

20. The sealing ring as recited claim 18, wherein the first conical surface has a stiffening bead at an end axially facing the radial flange and a ratio of a length of the first conical surface to a length of the second conical surface is 0.3 to 0.8.

21. The sealing ring as recited in claim 20, wherein the stiffening bead is formed as one piece and integrally with the sealing sleeve.

22. The sealing ring as recited in claim 20, wherein the stiffening bead is formed by a separately produced back ring joined to the sealing sleeve.

23. The sealing ring as recited in claim 20, wherein the stiffening bead is formed by a separately produced back ring disposed non-adhesively between the sealing sleeve and the supporting ring.

24. The sealing ring as recited in claim 22 wherein the back ring includes a PTFE compound.

25. The sealing ring as recited in claim 19, wherein the sealing sleeve is configured so that in the absence of the machine element, the sealing lip would extend beyond the surface of the machine element by an overlap distance, the overlap distance being smaller than a clearance between the outer circumferential surface of the outer axial leg and the axial flange of the supporting ring.

26. The sealing ring as recited in claim 1, wherein the supporting ring is part of a housing cover.

27. The sealing ring as recited in claim 1, wherein the supporting ring includes a protective lip extending from a side of the radial flange distal to the sealing lip and sealingly enclosing the radial surface of the machine element.

28. A sealing arrangement for sealing an axially arranged machine element, comprising:
a first sealing ring, including:
a first stiffening ring of hard material;
a first supporting ring having a first radial flange positioned adjacent a first radial surface of the machine element so as to form a first radial gap between the first radial flange and the surface of the machine element; and
a first sealing sleeve of elastomer material connected to the first stiffening ring, the first sealing sleeve including a first sealing lip for sealing against the radial surface so as to create a first sealed-off space, a first outer axial leg, and a first radial leg connecting the first sealing lip to the first outer axial leg, wherein the first outer axial leg includes a first outer circumferential surface and a first proximate end proximate to the first sealed-off space, the first outer axial leg being connected to the first stiffening ring only at the first proximate end, wherein the first radial leg has a first distal surface distal to the sealed-off space, and wherein the first distal surface and the first outer circumferential surface are associated non-adhesively with the first supporting ring; and
a second sealing ring including:
a second supporting ring of a hard material and having a second radial flange and a second axial flange, and
a second sealing sleeve of elastomer material having a second sealing lip for sealing a second sealed-off space disposed axially adjacently to the first sealed off space, the second sealing sleeve being connected to the second supporting ring, wherein the first sealing ring and the second sealing ring are joined to form a preassemblable unit.

29. The sealing arrangement as recited in claim 28, wherein the first sealing ring and the second sealing ring are laterally symmetrical with respect to an imaginary radial plane.

30. The sealing arrangement as recited in claim 28 wherein the first radial flange and the second radial flange are inegrally formed as a single piece and are of the same material.

31. The sealing arrangement as recited in claim 28, wherein the first radial flange and the second radial flange are separate pieces joined together and are non-rotatably relative to each other.

32. The sealing arrangement as recited in claim 28, wherein a longitudinal section of the first sealing sleeve forms an essentially C-shape that opens axially toward the first sealed-off space and a wherein a longitudinal section of the second sealing sleeve forms an essentially C-shape that opens axially toward the second sealed-off space.

33. The sealing arrangement as recited in claim 32, wherein the second sealing sleeve includes a second radial leg, a second outer axial leg and a second inner axial leg, each of the second inner and second outer axial legs having second proximate ends proximate to the second sealed-off space and second distal ends distal to the sealed off space, the second radial leg connecting the second distal ends, wherein the second outer axial leg is joined to the second axial flange only at the second proximate end, and wherein a second outer circumferential surface of the second outer axial leg and a second distal side of the second radial leg distal to the second sealed-off space are associated non-adhesively with the second supporting ring.

34. The sealing arrangement as recited in claim 28, wherein the second radial flange is disposed positioned adjacently to the radial surface of the machine element forming a second radial gap between the second radial flange and the radial surface.

35. The sealing arrangement as recited in claim 28, wherein a radial width of the second radial gap is 0.01 to 0.2 mm.

36. The sealing arrangement as recited in claim 35, wherein the radial width of the second radial gap is 0.03 to 0.08 mm.

37. The sealing arrangement as recited in claim 28, wherein the second outer circumferential surface and the second distal surface of the second radial leg are disposed adjacent to the second supporting ring with clearance therebetween and are configured to be moveable to a position against the second supporting ring.

38. The sealing arrangement as recited in claim 28 wherein the second outer circumferential surface rests against the second supporting ring and the second distal surface of the second radial leg is disposed adjacent the second supporting ring with clearance therebetween, the second distal surface configured to be moveable to a position resting against the second supporting ring.

39. The sealing arrangement as recited in claim 28, wherein the first and second supporting rings includes a metallic material.

40. The sealing arrangement as recited in claim 28, wherein the first and second supporting rings include a polymer material.

41. The sealing arrangement as recited in claim 28, further comprising a second annular helical spring disposed around an outside of the second inner axial leg so as to increase a contact pressure of the second sealing lip against the radial surface of the machine element.

42. The sealing arrangement as recited in claim 28, wherein at least one of the second outer axial leg, the second radial leg, and the second supporting ring have a friction-reducing surface coating.

43. The sealing arrangement as recited in claim 42, wherein the friction-reducing surface coating includeds a PTFE film.

44. The sealing arrangement as recited in claim 42, wherein the friction-reducing surface coating includeds a lacquer.

45. The sealing arrangement as recited in claim 28, wherein the second sealing sleeve includes a first conical surface distal to the second sealed-off space and a second conical surface proximate to the second sealed-off space, the first conical surface intersecting the second conical surface so as to form the second sealing lip, a first cone angle formed by the first conical surface and an axis of the machine element being not more than 10° smaller than a second cone angle formed by the second conical surface and the axis.

46. The sealing arrangement as recited in claim 28, wherein the second supporting ring has an angle ring design.

47. The sealing arrangement as recited in claim 28, wherein the second sealing sleeve is configured so that in the absence of the machine element, the second sealing lip would extend beyond the surface of the machine element by an overlap distance, the overlap distance being smaller than a clearance between the second outer circumferential surface of the second outer axial leg and the second axial flange of the second supporting ring.
